(19) United States
(12) Patent Application Publication
(10) Pub. No.: US 2012/0006810 A1
(43) Pub. Date: Jan. 12, 2012

(54) INDUCTION HEATING-ASSISTED VIBRATION WELDING METHOD AND APPARATUS

(75) Inventors: Hua-Tzu Fan, Troy, MI (US); Wayne W. Cai, Troy, MI (US); Paul F. Spacher, Rochester, NY (US)

(73) Assignee: GM GLOBAL TECHNOLOGY OPERATIONS LLC, Detroit, MI (US)

(21) Appl. No.: 13/010,831

(22) Filed: Jan. 21, 2011

Related U.S. Application Data
(60) Provisional application No. 61/363,022, filed on Jul. 9, 2010.

(51) Int. Cl. B23K 13/01

(52) U.S. Cl. 219/617

(57) ABSTRACT

A method for heating a work piece or a welding interface using a vibration welding system includes positioning the work piece adjacent to a welding tool such that the welding interface is also adjacent to the welding tool, and then using an induction heating device to generate an eddy current in one of the welding tool and the work piece to thereby heat the welding interface to a calibrated threshold temperature or temperature range. A high-frequency vibration thereafter may be applied using a sonotrode of the vibration welding system to form a weld. The method may include adjusting the position and orientation of the induction heating device relative to the work piece to change the location of the eddy current. A vibration welding system includes a welding tool, the induction heating device, and a control module which controls the induction heating device to thereby control the welding temperature.

### CROSS REFERENCE TO RELATED APPLICATIONS

This application claims the benefit of U.S. Provisional Patent Application No. 61/363,022, filed Jul. 9, 2010, which is hereby incorporated by reference in its entirety.

### TECHNICAL FIELD

The present invention relates to an induction heating-assisted vibration welding method and apparatus.

### BACKGROUND

The process of vibration welding can be used to securely join adjacent surfaces of one or more work pieces. A weld is formed by applying vibrations to the work piece in a calibrated range of frequencies and directions. The work piece is first positioned and clamped between a stationary anvil and a welding horn or sonotrode. When energized, the sonotrode transmits vibration energy through the work piece. Heat generated by the friction softens the material of the work piece along the interfacing surfaces, which ultimately forms a solid weld. The efficiency, consistency, and reliability/durability of a vibration-welded part depend largely on the design of the sonotrode, the anvil, and various other welding tools and control equipment used to form the welds.

### SUMMARY

A vibration welding method and system are provided for increasing a temperature of a selected portion of a work piece or multiple work pieces, and/or a selected welding interface defined by the work piece(s), during a vibration welding process. The method includes heating the selected portion or welding interface using an induction heating device, which may be embedded within a welding anvil or another designated welding tool in one possible embodiment. The position and/or orientation of the induction heating device relative to the work piece determines the position of a generated eddy current with respect to the same work piece, and thus determines the particular welding interface to be heated.

In a vibration welding process, the temperature in a weld zone drops as heat energy from the vibrations of the sonotrode dissipates. Even if equal amounts of heat can be generated at each of the different possible welding interfaces for a given multiple-sheet welding configuration, the welding temperature at a given welding interface may differ drastically from that of other interfaces. This is largely due to different friction conditions, different relative motion between the surfaces of the work piece, and heat sink effects. Therefore, a designated portion of the work piece, such as the thickest portion of the work piece or the surface or component of the work piece having the highest thermal conductivity, can be selectively heated via induction as set forth herein using the induction heating device.

In particular, a method is disclosed herein for heating of a work piece and/or a welding interface formed using a vibration welding system, wherein the welding interface is defined by adjacent surfaces of a work piece being welded. The method includes positioning the work piece adjacent to a welding tool such that the welding interface is also adjacent to the welding tool, and then using an induction heating device to generate an eddy current in one of the welding tool and the work piece. Once the eddy current is generated within all conductors in an electromagnetic field surrounding the energized induction heating device, the welding interface is heated to a calibrated threshold temperature via conduction, or to within a calibrated temperature range. The work piece may thereafter be vibration welded using a sonotrode of the vibration welding system, either concurrently or after the aforementioned heating step.

Additionally, a vibration welding system for welding adjacent surfaces of a work piece using vibration energy includes a welding tool, an induction heating device embedded within the welding tool, and a controller. The induction heating device, once energized, generates eddy current(s) sufficient for heating a welding interface defined by adjacent surfaces of the work piece. The controller modulates the current and the frequency transmitted to the induction heating device to maintain the welding temperature above a calibrated threshold. The design, position, and orientation of the induction heating device ultimately determine whether the welding tool or the work piece is most thoroughly heated.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration of a vibration welding system having an induction heating device as disclosed herein;

FIG. 2 is a perspective side view illustration of a welding tool having an embedded induction heating device according to one possible embodiment;

FIG. 3 is schematic side view illustration of the welding tool of FIG. 2 being used to form a weld in a work piece;

FIG. 4 is a perspective side view illustration of a welding tool having an embedded induction heating device according to another possible embodiment; and

FIG. 5 is a flow chart describing a method for heating a welding interface during a vibration welding process using the system shown in FIG. 1.

### DESCRIPTION

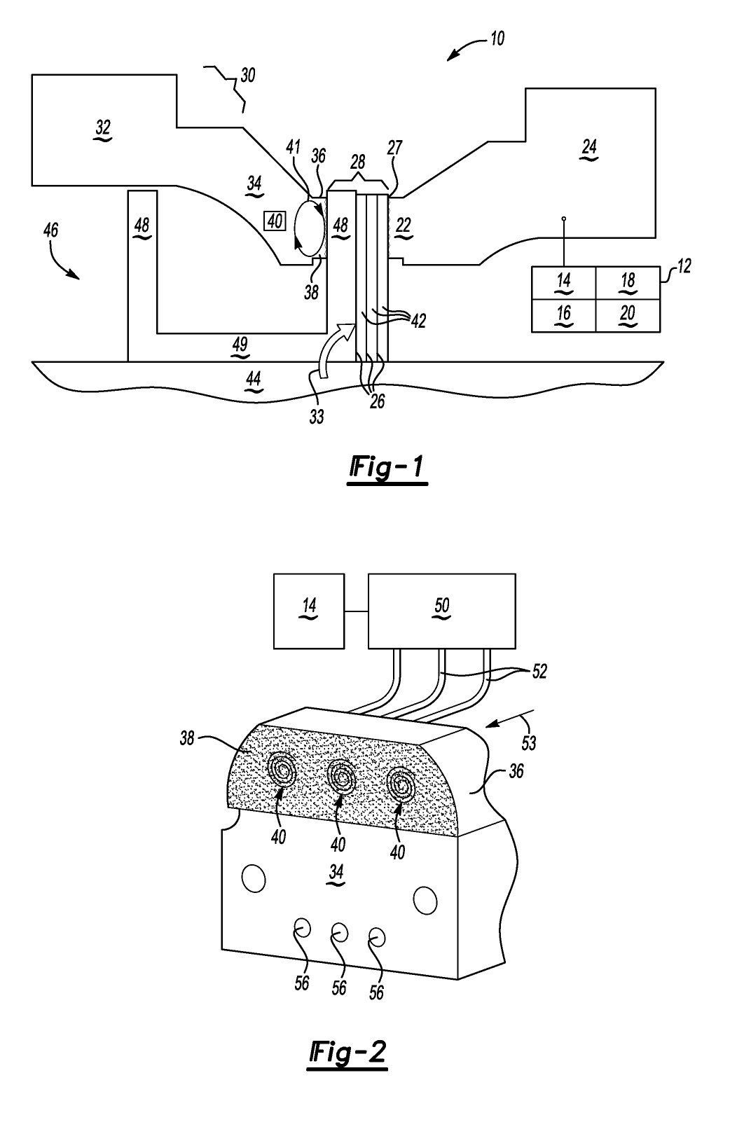

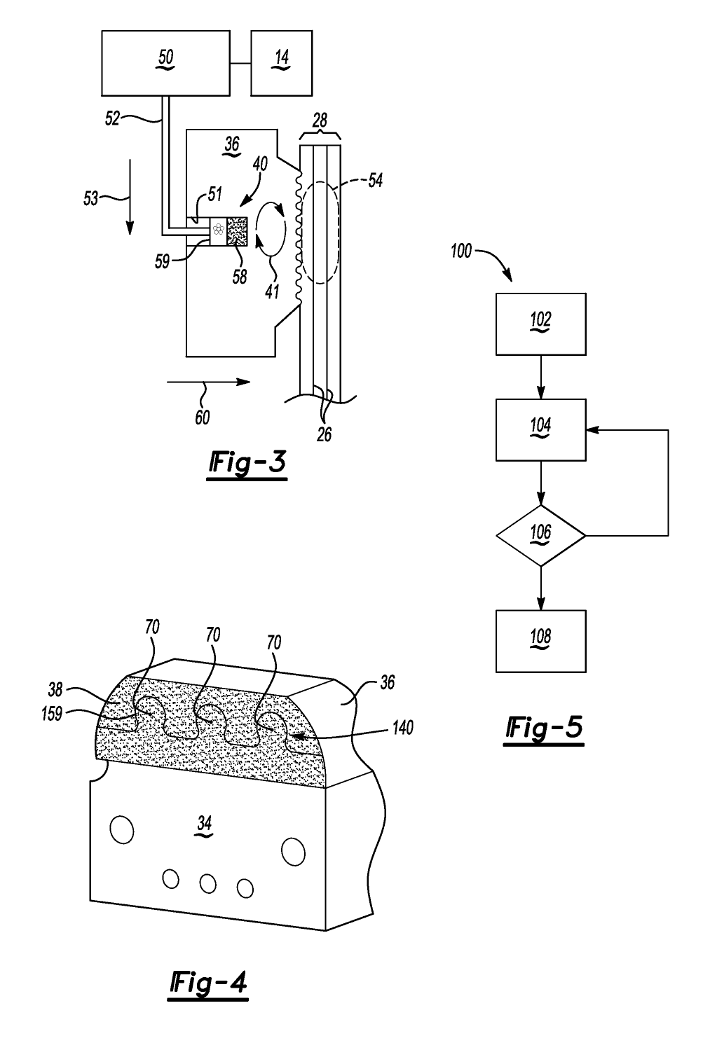

Referring to the drawings, wherein like reference numbers refer to like components, and beginning with FIG. 1, a vibration welding system 10 is configured for forming a weld using ultrasonic vibrations, or using vibrations of other suitable frequencies. Localized heating is provided via one or more induction heating devices 40. Each induction heating device 40 is used to heat a work piece 28, which while used in the singular herein may include multiple pieces. The induction heating device 40 raises a welding temperature via conduction at or along one or more welding interfaces 26, i.e., the interfacing adjacent surfaces of the work piece(s) 28 which are to be welded together. Heating of a welding tool such as an anvil assembly 30 is one possible way of heating the welding interface(s) 26, as noted below with reference to FIGS. 2 and 3, with the ultimate goal of heating the work piece 28 and a particular welding interface.

The welding system 10 may include welding control equipment 12. The welding control equipment 12 includes a welding power supply 14 operable for transforming an available source power into a form readily usable in vibration welding. As understood by those of ordinary skill in the art, a welding power supply used in a vibration welding process, such as the welding power supply 14 shown in FIG. 1, can be electrically-connected to any suitable energy source, e.g., a 50-60 Hz wall socket. The welding power supply 14 may include a welding controller 16, which is usually but not necessarily integrally included within the welding power supply.

The welding power supply 14 and the welding controller 16 ultimately transform source power into a suitable power control signal having a predetermined waveform characteristic(s) suited for use in the vibration welding process, for example a frequency of several hertz (Hz) to approximately 40 KHz, or much higher frequencies depending on the particular application. The power control signal is transmitted from the welding power supply 14 or the welding controller 16 to a converter 18 having the required mechanical structure for producing a mechanical vibration in one or more welding pads 22. The welding pads 22 may be integrally-formed with or connected to a vibrating welding horn or sonotrode 24.

The vibration welding system 10 may also include a booster 20. The booster 20 may be any device configured for amplifying the amplitude of vibration, and/or for changing the direction of an applied clamping force. That is, a vibration signal from the welding controller 16 may have a relatively low amplitude initially, e.g., a fraction of a micron up to a few millimeters, which can then be amplified via the booster 20 to produce the required mechanical oscillation. The vibration signal is in turn transmitted to the one or more welding pads 22 of the sonotrode 24.

A weld is ultimately formed at or along welding interfaces 26 between adjacent surfaces of the work piece 28. The welding system 10 may be used to weld or join metals or thermoplastics by varying the orientation of the vibrations emitted by the sonotrode 24. That is, for thermoplastics the vibrations emitted by the sonotrode 24 tend to be perpendicular to the surface being welded, while for metals the direction may be generally tangential thereto.

Still referring to FIG. 1, each welding pad 22 may have knurls 27, i.e., textured surfaces contacting the work piece 28 during formation of a weld at or along the welding interface 26. The knurls 27 may be textured or configured as raised teeth and/or other frictional patterns providing a sufficient grip on the work piece 28 when the work piece is clamped. To further facilitate the welding process, the work piece 28 is positioned adjacent to the anvil assembly 30. The anvil assembly 30 may include a welder body 32, an anvil body 34, and an anvil head 36. The anvil head 36 may have knurls 38 that are similar in construction to the knurls 27 of the welding pad 22 as described above.

The induction heating device 40 is used to heat the work piece 28 and/or the welding interface 26, i.e., a designated interfacing surface of the work piece to be welded. That is, the work piece 28 may define multiple welding interfaces 26 as shown in FIG. 1, with the innermost weld location indicated in FIG. 1 by arrow 33. The induction heating device 40 may be positioned with respect to the work piece 28, e.g., surrounding the work piece. The induction heating device 40 may be alternately embedded as shown at various positions and/or orientations within a designated welding tool, e.g., a portion of the sonotrode 24 and/or portions of the anvil assembly 30.

Additionally, the position and/or orientation of the induction heating device 40 relative to the work piece 28 defining the welding interface 26 may be selected to thereby determine the position and orientation of an eddy current (arrow 41) generated by the induction heating device when the device is energized. The eddy current (arrow 41) ultimately heats the conductive metal materials within which the eddy current is generated, e.g., the anvil head 36 or the work piece 28.

The work piece 28 shown in the particular embodiment shown in FIG. 1 may include conductive tabs 42 of a multi-cell battery 44, only the top or interconnect board of which is shown in FIG. 1 for simplicity. The battery 44 may be used for electric propulsion of a vehicle (not shown), and may include a conductive bus bar or interconnect member 46. The interconnect member 46 may have side rails 48 that are connected to each other by a cross member 49. In this embodiment, the conductive tabs 42 form electrode extensions of respective battery cells, and are each internally-welded to the various anodes and cathodes comprising that particular cell as will be well understood by those of ordinary skill in the art. The interconnect member 46 may be constructed of a suitable conductive material, e.g., copper, and may be shaped, sized, and/or otherwise configured to form a rail or bus bar, and mounted to the battery 44.

Potential uses for the battery 44 include the powering of various onboard electronic devices and propulsion in a hybrid electric vehicle (HEV), an electric vehicle (EV), a plug-in hybrid electric vehicle (PHEV), and the like. By way of example, the battery 44 could be sufficiently sized to provide the necessary voltage for powering an electric vehicle or a hybrid gasoline/electric vehicle, e.g., approximately 300 to 400 volts or another voltage range, depending on the required application.

As the sonotrode 24 of FIG. 1 clamps against the anvil assembly 30 and traps the work piece 28, the sonotrode vibrates at a calibrated frequency and amplitude to generate friction and heat along the welding interfaces 26. However, the anvil assembly 30 can act as a substantial heat sink, and therefore heat is lost as energy is transmitted from the sonotrode 24 toward the anvil assembly. Potentially, the innermost weld, indicated by arrow 33 in FIG. 1, i.e., the farthest weld spot away from the sonotrode 24, has the lowest relative temperature, and hence potentially forms the weakest bond. This effect can be counteracted by heating the welding interface(s) 26 as disclosed below.

Referring to FIG. 2, the induction heating device(s) 40 may be embedded within one or more welding tools of the welding system 10 shown in FIG. 2 in one embodiment. Three induction heating devices 40 are shown in FIG. 2 to correspond to three different weld spots in one possible embodiment. The number of induction heating devices 40 used in a particular embodiment may vary. For example, the anvil body 34 may define a channel 51 (see FIG. 3) in which a corresponding one of the induction heating device 40 are positioned. Since the anvil head 36 is relatively small, the induction heating devices 40 may be sized accordingly, e.g., the channel 51 of FIG. 3 may be approximately 8 mm in diameter in one embodiment, with the induction heating device sized to fit within this diameter.

The induction heating device 40 is electrically connected to the welding power supply 14 or to another 110V or 220V power supply via a control module 50 and wires 52. The wires 52 may be constructed of insulated silver (Ag) or insulated copper (Cu) according to one possible embodiment, thereby optimizing energy transfer to the induction heating device 40. Such an embodiment may be of particular benefit when welding copper or aluminum, e.g., the conductive tabs 42 of the battery 44 shown in FIG. 1. The welding interface 26 at the innermost weld, as indicated by arrow 33 in FIG. 1, tends to have the weakest bonding strength. An eddy current (arrow 41) is therefore centered on that particular location in order to produce a better bond between welded surfaces of the work piece 28.

Also, the control module 50 may be used to modulate the electrical current and frequency of an alternating current (AC) signal (arrow 53) transmitted to the induction heating device 40. Use of a high frequency AC current, e.g., approximately 25 kHz or higher, may facilitate generation of the eddy current (arrow 41) in the work piece 28 of FIG. 1, and/or the anvil head 36, or in another welding tool containing the induction heating device 40. The control module 50 may be part of the welding controller 16 shown in FIG. 1, or it may be a separate control device. The control module 50 regulates the welding temperature by controlling the properties of the AC power signal 53 delivered to the induction heating device 40. The anvil body 34 is also shown with the anvil head 36 and knurls 38, as well as with a plurality of mounting holes 56 which receive fasteners (not shown). In this manner, the anvil body 34 may be mounted to the welder body 32 shown in FIG. 1.

Sizing of the induction heating device 40 may be determined by the nature of the immediate welding task. For example, heating up a copper work piece having an area of 1 cm×1 cm×0.20 cm, which is approximately four times the area of a typical weld spot, within 1 second (s) requires, according to one possible formula, power (P) of VcᵥΔT/t, where V is the volume of the work piece (in m³), cᵥ is the volumetric specific heat capacity in Joules (J)/centimeter (cm)³ Kelvin (K), t=1 s, and ΔT=130° K, i.e., the desired increase in welding temperature.

The magnetic flux density (B) required to deliver the required power (P) via the eddy current (arrow 41) may be calculated as: B=\sqrt{6ρD}/(πdf), where ρ is the static resistivity of the material being welded, in this example copper, D is the penetration depth of the weld, d is the sheet thickness, and f is the frequency in Hz. The electrical current (I) required to generate the flux density (B) can be determined using the equation: I=FBh/μN, where F is a calibrated safety factor, h is the magnetic flux loop height at the penetration depth (D), μ is the permeability of air, and N is the number of loops in the induction heating device 40 at the stated safety factor (F).

From the stated formulas, which are indeed to be exemplary and not necessarily applicable to all possible applications, even given a conservative safety factor (F) of 10 when welding a relatively thin copper sheet (d=0.001 m) with a weld penetration depth (D) of 0.0005 m, at a frequency (f) of 25 kHz, the electrical current (I) required for generating eddy currents (arrow 41) collectively providing sufficient heating is less than approximately 5 mA. This low level of electrical current can provide cost advantageous improvement in the resultant weld quality of certain welding applications.

Referring to FIG. 3, the induction heating device 40 may include induction coils 59, which are insulated from each other, and a suitable insulator end 58 such as a glass or ceramic layer, disc, or cylinder. The location of the eddy current (arrow 41) generated by the induction coils 59 is shown in FIG. 3 within the anvil head 36, which is just one possible embodiment. Such an embodiment would tend to heat the anvil head 36, with this heat being transferred via conduction to the work piece 28 when the anvil head 36 contacts the work piece. The work piece 28 of FIG. 3 is shown as a three-piece stack up, which depending on the embodiment may or may not include the tabs 42 of FIG. 2 and the side rail 48 shown in that Figure.

The location of the eddy current (arrow 41) may be varied toward and, if desired, into the work piece 28 simply by positioning the induction coils 59 closer to the work piece, i.e., by moving the coils in the direction of arrow 60. The induction coils 59 may be hollow tubes to allow for fluid cooling or may be cooled by other means to prevent overheating. One embodiment extends the channel 51 deeper into the anvil head 36 to allow closer fixed positioning of the induction coils 59 with respect to the work piece 28. Positioning of the induction coils 59 is variable within the extended channel 51 in another embodiment. For example, the insulator ends 58 of different thicknesses could be inserted into the channel 51 to vary the distance between the induction coils 59 and the welding interface 26 being welded to form a given weld 54.

Referring to FIG. 4, in an alternate embodiment an induction heating device 140 may include partial or full loops 159 arranged in electrical series from a single length of wire. Each of the loops 159 may be positioned and oriented to at least partially circumscribe a center point 70 of a weld being formed, e.g., the weld 54 shown in FIG. 3. The loops 159 can be positioned in a variant of the channel 51 shown in FIG. 3 if the channel is a through-hole positioned below a valley or lowest point of the knurls 38 of the anvil head 36. Such a position can also help to protect the loops 159 from damage during the vibration welding process. However, in other embodiments channels (not shown) may be formed in the knurl pattern at a depth which minimizes any possibility of contact with the loops 159. Regardless of the positioning or orientation of the loops 159 with respect to the welding tool within which the loops are embedded, the loops should be sufficiently insulated from each other.

Referring to FIG. 5, a method 100 is described with reference to the structure shown in the various Figure. The method 100 can be used for heating a work piece and/or a welding interface, e.g., the work piece 28 or welding interface 26 shown in FIG. 1, during a vibration welding process using the welding system 10 shown in the same Figure. At step 102, a work piece 28 is positioned between the sonotrode 24 and the anvil assembly 30, with the work piece defining a welding interface 26. Step 102 may include positioning the conductive tabs 42 of the battery 44 shown in FIG. 1 and an interconnect member 46 of the same Figure adjacent to each other and between the sonotrode 24 and the anvil assembly 30, with one of the welding interfaces being the innermost position indicated in FIG. 1 by arrow 33.

Once positioned, at step 104 one or more induction heating devices 40, 140 are energized to generate the eddy current (arrow 41) shown in FIGS. 1 and 3. The eddy current (arrow 41) heats the welding tool, e.g., a portion of the anvil assembly 30, and/or the work piece 28, to thereby increase the welding temperature at or along a designated one of the welding interfaces 26 before vibrations are transmitted by the sonotrode 24. The method 100 then proceeds to step 106.

At step 106, a designated controller, e.g., the welding controller 16 of FIG. 1 or the control module 50 of FIG. 2, uses a closed loop feedback control approach to determine when welding temperature at or along the designated welding interface 26 reaches a calibrated temperature threshold, or falls within a calibrated temperature range. For example, thermocouples may be used to measure the temperature at the designated welding interface 26, or in the vicinity of the welding interface, e.g., within the channel 51 of FIG. 3 or a variant thereof. The measured temperature can be used by the designated controller in regulating a performance of the induction heating device 40, 140 to maintain the temperature within a calibrated range. The sonotrode 24 may be vibrating at this point, with the friction heating from the knurls 27, 38 (see FIG. 1) increasing the welding temperature in conjunction with heat generated via the eddy currents (arrow 41) by the induction heating device(s) 40, 140. Step 104 is repeated if the sensed temperature is less than the calibrated temperature threshold, with method 100 otherwise proceeding to step 108.

At step 108, the weld is completed. The method 100 may then repeat step 102 for a subsequent weld.

While the best modes for carrying out the invention have been described in detail, those familiar with the art to which this invention relates will recognize various alternative designs and embodiments for practicing the invention within the scope of the appended claims.

1. A vibration welding method comprising:
positioning a work piece adjacent to a welding tool, such that the work piece defines a welding interface adjacent to the welding tool;
using an induction heating device to generate an eddy current in one of the welding tool and the work piece to thereby heat the work piece or the welding interface, via conduction, to a calibrated threshold temperature; and
forming a weld using vibrations from a sonotrode after the work piece or welding interface reaches the calibrated threshold temperature.

2. The method of claim 1, further comprising: embedding the induction heating device within the welding tool.

3. The method of claim 2, wherein embedding the induction heating device within the welding tool includes embedding the induction heating device in an anvil head.

4. The method of claim 1, wherein using an induction heating device to generate an eddy current includes:
automatically modulating an alternating current (AC) electrical signal to generate a modulated AC electrical signal; and
transmitting the modulated AC electrical signal to the induction heating device via a control module.

5. The method of claim 1, wherein positioning the work piece includes positioning a conductive interconnect member and a conductive tab of a battery adjacent to a stationary welding anvil.

6. The method of claim 1, further comprising:
adjusting the position of the induction heating device relative to the work piece to thereby change the location of the eddy current with respect to the work piece.

7. A vibration welding system for welding adjacent surfaces of a work piece using vibration energy, the welding system comprising:
a welding tool;
an induction heating device configured for heating the work piece or a welding interface defined by the adjacent surfaces of the work piece; and
a control module configured to control an operation of the induction heating device to thereby control the welding temperature at or along the welding interface to a calibrated threshold temperature.

8. The welding system of claim 7, wherein the induction heating device includes at least one induction coil positioned within a channel defined by the welding tool.

9. The welding system of claim 7, wherein the induction heating device includes an insulating layer positioned between the at least one induction coil and the work piece.

10. The welding system of claim 7, wherein the induction heating device is connected to a welding power supply via one of an insulated silver wire and an insulated copper wire, and the work piece is one of a copper and an aluminum conductive tab of a battery.

11. The welding system of claim 7, wherein the control module is configured to automatically modulate an alternating current (AC) electrical signal to generate a modulated AC electrical signal having a frequency of at least approximately 25 KHz, and to transmit the modulated AC electrical signal to the induction heating device.

12. An anvil assembly for use as a welding tool in a vibration welding system, wherein the vibration welding system is configured for welding adjacent surfaces of a work piece using vibration energy, the anvil assembly comprising:
an anvil body;
an anvil head operatively connected to the anvil body; and
an induction heating device configured for heating the work piece or a welding interface defined by the adjacent surfaces of the work piece;
wherein the induction heating device is configured to increase a welding temperature at or along the welding interface to a calibrated threshold temperature.

13. The anvil assembly of claim 12, wherein the induction heating device includes an induction coil positioned within a channel defined by the anvil head.

14. The anvil assembly of claim 12, wherein the induction heating device further includes an insulating layer positioned between the at least one induction coil and the work piece.

15. The anvil assembly of claim 12, wherein the induction heating device receives a modulated AC electrical signal having a frequency of at least approximately 25 KHz from a control module of the welding system, and increases the welding temperature in response to the modulated AC electrical signal.

16. The anvil assembly of claim 12, wherein the vibration welding system is configured for simultaneously forming a plurality of weld spots when welding the adjacent surfaces of the work piece, further comprising: a plurality of the induction heating devices that is equal to the number of the plurality of weld spots.

17. The anvil assembly of claim 12, wherein the work piece is copper conductive battery tab that is approximately 0.2 centimeters thick.
